(19) United States
(12) Patent Application Publication
(10) Pub. No.: US 2010/0191627 A1
(43) Pub. Date: Jul. 29, 2010

(54) ACCOUNTING DEVICE AND ACCOUNTING METHOD

(75) Inventors: Takashi Makiyama, Tokyo (JP); Yumiko Okuma, Tokyo (JP); Hisashi Sato, Tokyo (JP); Masanori Sambe, Tokyo (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/683,046

(22) Filed: Jan. 6, 2010

(30) Foreign Application Priority Data
Jan. 26, 2009 (JP) 2009014620
Jul. 2, 2009 (JP) 2009158177

(51) Int. Cl. G06Q 30/00; G06Q 10/00

(52) U.S. Cl. 705/30

(57) ABSTRACT

An accounting device includes: a first calculation unit which calculates a total amount for ordered menu items; a second calculation unit which calculates an estimate deposit amount as a result of adding, to the total amount calculated by the first calculation unit, a difference between an amount in a processing target digit of the total amount and an amount of a coin or banknote that is more expensive than the amount in the processing target digit; a display control unit which displays an operation image to input the estimate deposit amount calculated by the second calculation unit; and an input acceptance unit which accepts input of the estimate deposit amount calculated by the second calculation unit corresponding to the operation image when the displayed operation image is operated.

### CROSS-REFERENCE TO RELATED APPLICATION

This application is based upon and claims the priority of Japanese Patent Application No. 2009-014620, filed on Jan. 26, 2009, and Japanese Patent Application No. 2009-158177, filed on Jul. 2, 2009, the entire contents of which are incorporated herein by reference.

### TECHNICAL FIELD

The present invention relates to an accounting device and an accounting method installed in an eating and drinking place such as a restaurant and adapted to assist customer service by inputting guide information for customers, order information of items on the menu, and so on.

### BACKGROUND

In many eating and drinking places, for example, family restaurants and bars, an order management system is constructed that can integrally manage orders of food and drink items on the menu to accounting (see JP-A-2008-299821). The system disclosed in JP-A-2008-299821 includes an accounting device such as an electronic cash register or POS (point of sales) terminal installed on the cash desk, which is the accounting place where the bill is paid, a station which executes management of various kinds of information sent from the accounting device, a slip issuing printer which is connected to the accounting device and prints and issues order slips, and a kitchen printer which prints and outputs cooking indication slips. In the system disclosed in JP-A-2008-299821, the station, the slip issuing machine, the kitchen printer and the accounting device are connected via a communication network such as a LAN (local area network).

In the accounting device disclosed in JP-A-2008-299821, when inputting a deposit amount at the time of accounting for ordered items on the menu, the operator touches ten-keys arranged on an order input screen, each having a one-digit number described thereon, and thus inputs the deposit amount. However, if the deposit amount is large, the operator must input touch the ten-keys many times to input the deposit amount. This very low operability causes burden on the operator.

### SUMMARY

According to an aspect of the invention, an accounting device includes: a first calculation unit which calculates a total amount for ordered menu items; a second calculation unit which calculates an estimate deposit amount as a result of adding, to the total amount calculated by the first calculation unit, a difference between an amount in a processing target digit of the total amount and an amount of a coin or banknote that is more expensive than the amount in the processing target digit; a display control unit which displays an operation image to input the estimate deposit amount calculated by the second calculation unit; and an input acceptance unit which accepts input of the estimate deposit amount calculated by the second calculation unit corresponding to the operation image when the displayed operation image is operated.

According to another aspect of the invention, an accounting method includes: calculating a total amount for ordered menu items; calculating an estimate deposit amount as a result of adding, to the calculated total amount, a difference between an amount in a processing target digit of the total amount and an amount of a coin or banknote that is more expensive than the amount in the processing target digit; displaying an operation image to input the calculated estimate deposit amount; and accepting input of the estimate deposit amount corresponding to the operation image when the displayed operation image is operated.

### DESCRIPTION OF THE DRAWINGS

FIG. 1 is a view of system configuration schematically showing the overall configuration of a customer service assistance system.

FIG. 2 is a block diagram showing electrical connection in an information terminal.

FIG. 3 is a block diagram showing electrical connection in a station.

FIG. 4 is a schematic view showing the file structure of a category file that is accessible to the information terminal and the station.

FIG. 5 is a schematic view showing the file structure of a PLU file that is accessible to the information terminal and the station.

FIG. 6 is a block diagram showing the functional configuration of the information terminal.

FIG. 7 is a front view showing an exemplary order input screen.

FIG. 8 is a flowchart showing a flow of order processing.

FIG. 9 is a front view showing an exemplary order input screen.

FIG. 10 is a front view showing an exemplary order input screen.

FIG. 11 is a schematic view showing the file structure of an order information file accumulated in the station.

FIG. 12 is a front view showing an exemplary accounting and payment operation screen.

FIG. 13 is a flowchart showing a flow of display processing to display a total amount button and an estimate amount button in a ten-key area.

### DETAILED DESCRIPTION

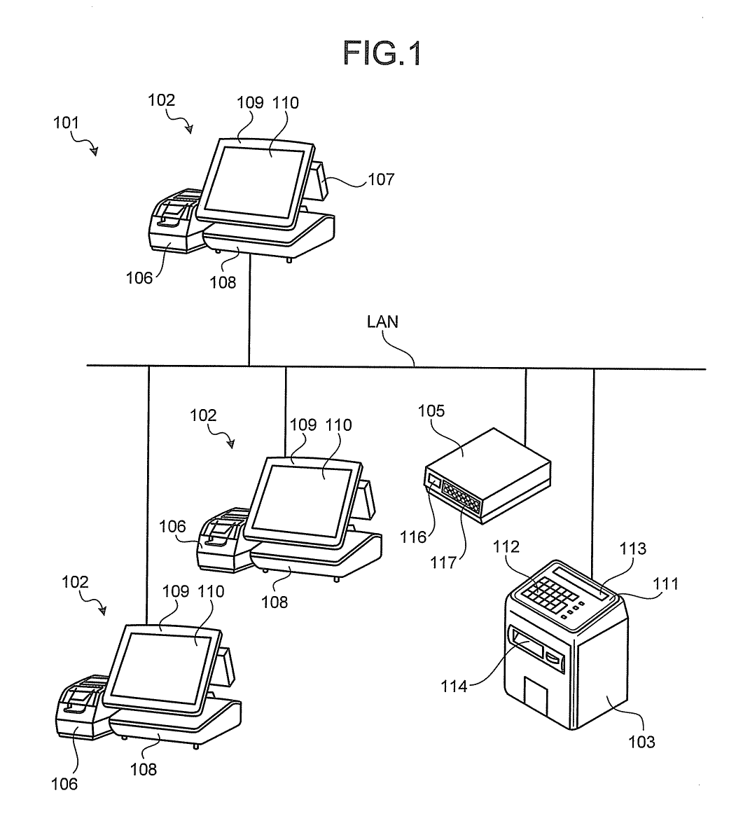

An embodiment of the invention will be described with reference to FIG. 1 to FIG. 13. This embodiment is an example where an information terminal of a customer service assistance system which assists in customer service including acceptance of orders and waiting (serving), in the entire flow of customer service of guiding incoming customers to a table arranged in a serving floor, accepting orders, and waiting (serving), is used as an accounting device.

FIG. 1 is a view of system configuration schematically showing the overall configuration of a customer service assistance system. A customer service assistance system 101 shown in FIG. 1 has an information terminal 102 installed in the serving floor and on the checkout counter, a kitchen printer 103 installed in the kitchen, a station 105 as a server that is installed in the backyard of the store and controls the entire customer service assistance system 101, and so on.

There is no difference in the basic structure and functions between the information terminal 102 installed in the serving floor and the information terminal 102 installed on the checkout counter. The difference is how the information terminal 102 is used. That is, the information terminal 102 installed in the serving floor assists in services such as guiding customers, accepting orders, and waiting (serving). Meanwhile, the information terminal 102 installed on the checkout counter assists in accounting in addition to services such as guiding customers, accepting orders, and waiting (serving). That is, the information terminal 102 installed on the checkout counter functions as a so-called POS terminal as well. Because of the difference in the services in which the information terminal 102 assists, while a printer 106 to issue receipts and slips is connected to both the information terminal 102 installed in the serving floor and the information terminal 102 installed on the checkout counter, a customer-side display device 107 as well as the printer 106 is connected to the information terminal 102 installed on the checkout counter.

The information terminal 102 has a liquid crystal display 109 as a display device placed on the top of a body unit 108. The information terminal 102 has a touch panel 110 as an input device stacked on the display surface of the liquid crystal display 109. Also, the printer 106 is installed closely to the information terminal 102 and is connected to the information terminal 102 via an interface such as USB.

In the information terminal 102, the customer-side display device 107, for example, as an LED display device performing 7-segment display, is placed on the top of the body unit 108. Similarly to the printer 106, the customer-side display device 107 is connected to the information terminal 102 via an interface such as USB.

The top side of the kitchen printer 103 is an operation display surface 111, and a keyboard 112 and a display unit 113 are arranged on the operation display surface 111, as shown in FIG. 1. The kitchen printer 103 has, for example, a built-in thermal printer (not shown) and prints and issues cooking indication slips (not shown) for cooks working in the kitchen. The kitchen printer 103 issues cooking indication slips through a slip issue port 114 arranged on the front side.

The station 105 has a small-size liquid crystal display 116 and a keyboard 117, as shown in FIG. 1, and executes management or the like of various kinds of information sent from each information terminal 102.

In the customer service assistance system 101 outlined above, the information terminals 102, the kitchen printer 103 and the station 105 are connected so that data can be freely transmitted to and from each other via a LAN. Guide information about guiding customers to a table and order information about orders of menu items can be inputted to the information terminals 102. The inputted order information is transmitted to the station 105 via the LAN. The station 105 then sends the received order information to the kitchen printer 103 via the LAN. The kitchen printer 103 prints and issues a slip showing a content corresponding to the received order information. A slip that is printed and issued by the kitchen printer 103 is a cooking indication slip to indicate order menu items to cooks in the kitchen, as described above. The information terminal 102 functioning as a POS terminal executes accounting.

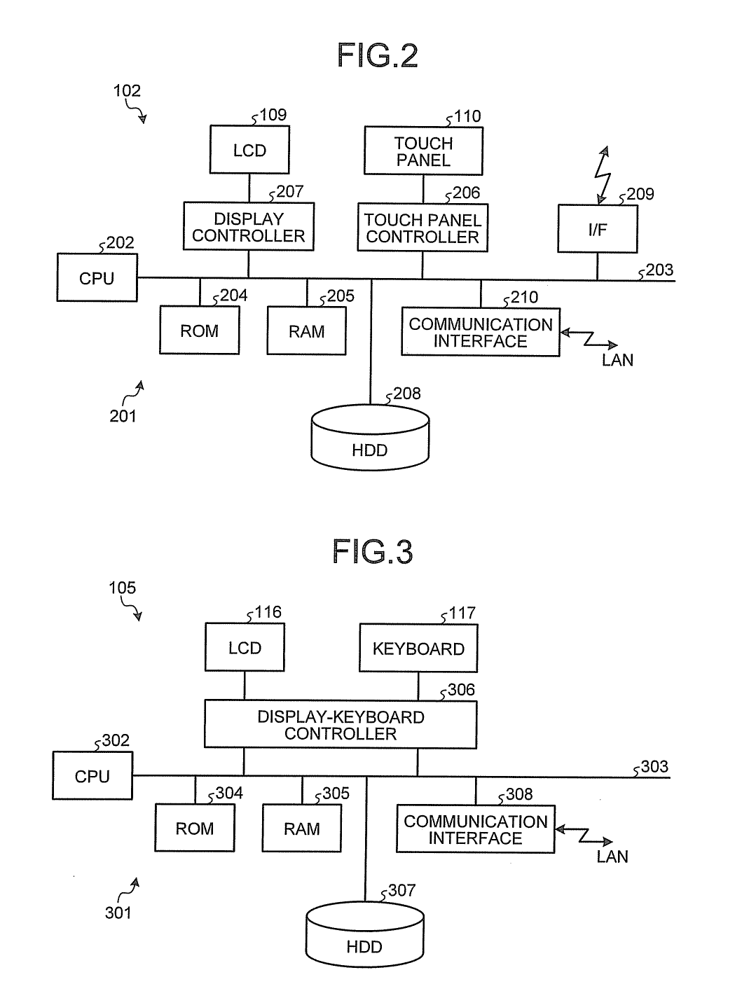

FIG. 2 is a block diagram showing electrical connection in the information terminal 102. As shown in FIG. 2, the information terminal 102 has a microcomputer 201. The microcomputer 201 controls driving of each unit. In the microcomputer 201, a ROM 204 which stores fixed information such as control programs in advance and a RAM 205 which rewritably stores various kinds of information and functions as a work area or the like are connected via a bus line 203 to a CPU 202 which centrally controls each unit. Therefore, the microcomputer 201 constitutes an information processing unit which executes information processing.

In the information terminal 102, a touch panel controller 206, a display controller 207, an HDD 208, an interface 209 and a communication interface 210 are connected to the microcomputer 201 via the bus line 203. The touch panel controller 206 takes an input signal from the touch panel 110 into the microcomputer 201. The display controller 207 controls driving of the liquid crystal display 109 in accordance with image data and causes the liquid crystal display 109 to display the image data. The interface 209 is an interface to connect the printer 106 and the customer-side display device 107 to the microcomputer 201. The interface 209 is, for example, USB. The communication interface 210 is an interface to communicate data between the microcomputer 201 and other devices via a LAN.

The information terminal 102 has an OS, computer programs, various files and so on installed in the HDD 208.

FIG. 3 is a block diagram showing electrical connection in the station 105. As shown in FIG. 3, the station 105 has a microcomputer 301. The microcomputer 301 controls driving of each unit. In the microcomputer 301, a ROM 304 which stores fixed information such as control programs in advance and a RAM 305 which rewritably stores various kinds of information and functions as a work area or the like are connected via a bus line 303 to a CPU 302 which centrally controls each unit. Therefore, the microcomputer 301 constitutes an information processing unit which executes information processing.

In the station 105, a display-keyboard controller 306, an HDD 307 and communication interface 308 are connected to the microcomputer 301 via the bus line 303. The display-keyboard controller 306 controls driving of the liquid crystal display 116 in accordance with image data and thereby causes the liquid crystal display 116 to display the image data. The display-keyboard controller 306 also takes an input signal from the keyboard 117 into the microcomputer 301. The communication interface 308 is an interface to communication data between the microcomputer 301 and other devices via a LAN.

The station 105 has an OS, computer programs, various files and so on installed in the HDD 307.

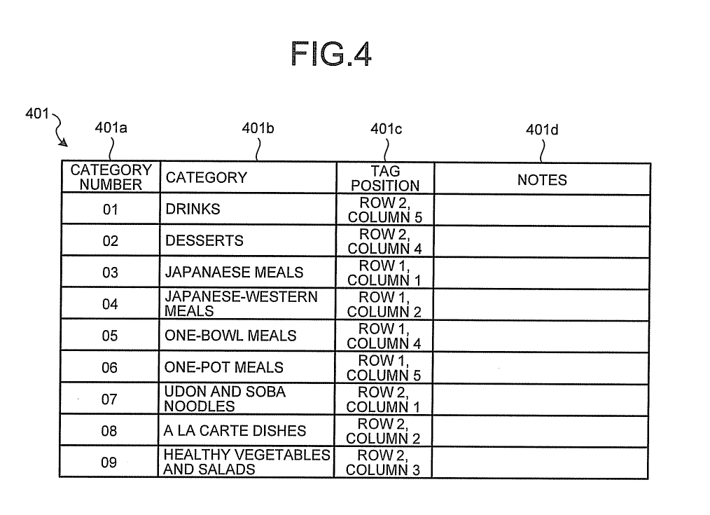

FIG. 4 is a schematic view showing the file structure of a category file 401 that is accessible to the information terminals 102 and the station 105. The category file 401 is installed in the HDD 208 of the individual information terminals 102 and in the HDD 307 of the station 105.

In the category file 401, categories 401b, tag positions 401c and notes 401d are registered in association with two-digit category numbers 401a specifying categories. In the category number section 401a, for example, the following categories are registered.

01: drinks

02: desserts

03: Japanese meals

04: Japanese-Western meals

05: one-bowl meals

06: one-pot meals

07: udon and soba noodles

08: a la carte dishes

09: healthy vegetables and salads

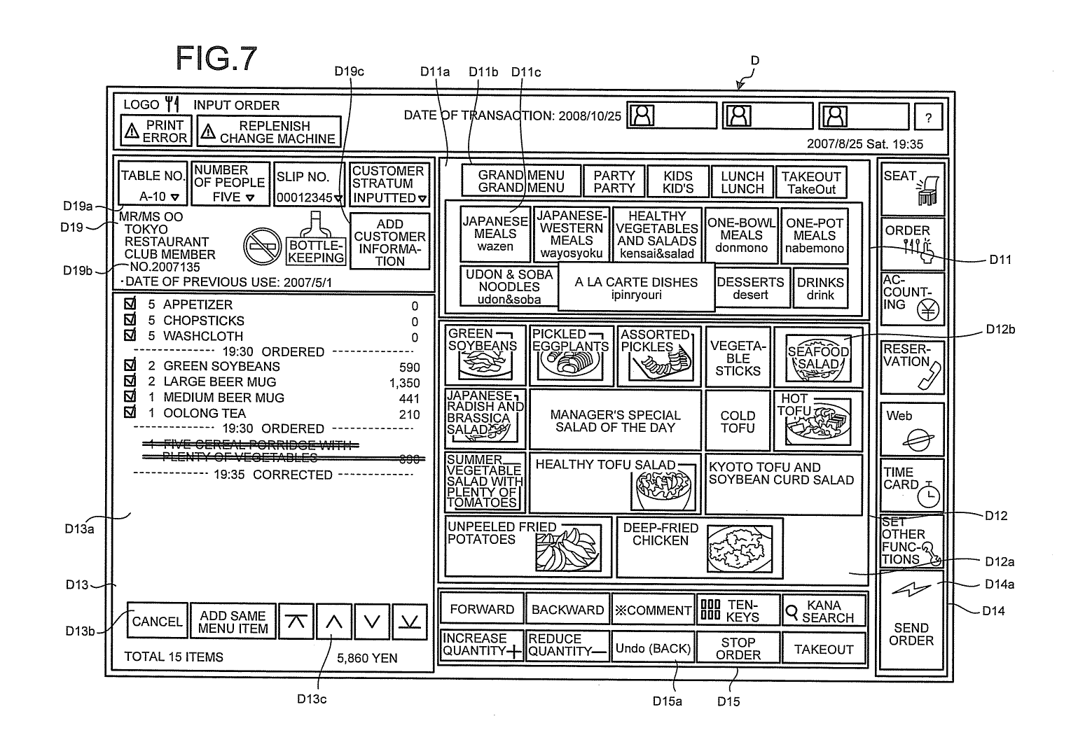

In the category section 401b of the category file 401, the category name of each category is registered. In the tag position section 401c of the category file 401, the arrangement of a main button D11b and a sub button D11c displaying a category name in a category tag section 11a (see FIG. 7) is registered. In this embodiment, in the tag position section 401c of the category file 401, the row and column indicating the position of the main button D11b and the sub button D11c is registered as the arrangement of the main button D11b and the sub button D11c. The notes section 401d is, for example, a section where various kinds of information can be written for information management.

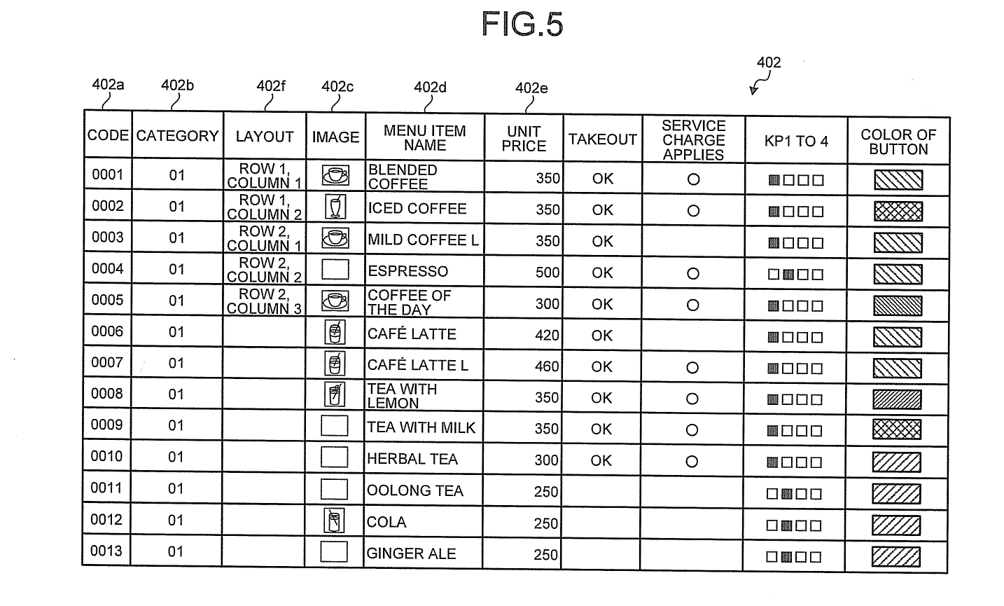

FIG. 5 is a schematic view showing the file structure of a PLU file 402 accessible to the information terminals 102 and the station 105. The PLU (price lookup) file 402 is installed in the HDD 208 of each of the information terminals 102 and in the HDD 307 of the station 105.

In the PLU file 402, categories 402b, image links 402c, menu item names 402d, unit prices 402e and layouts 402f are registered in association with codes 402a specifying menu items. The categories 402b represent the category numbers 401a in the category file 401. The image links 402c define links to image data displayed on menu buttons D12b in a menu item section D12a (see FIG. 7). The image data displayed on the menu buttons D12b are installed in the HDD 208 of the information terminals 102 and in the HDD 307 of the station 105. In the menu item name section 402d of the PLU file 402, the names of menu items are registered. In the unit price section 402e of the PLU file 402, the unit prices of menu items are registered. In the layout section 402f of the PLU file 402, the layout positions of the menu buttons D12b for menu items in the menu item section D12a (see FIG. 7) are registered. In this embodiment, in the layout section 402f of the PLU file 402, the row and column of each menu button D12b in the menu item section D12a are registered as the layout position of the menu button D12b.

For example, as can be seen from FIG. 4 and FIG. 5, a code “0001” specifying a menu item defines “blended coffee” in the “drinks” category and sets a unit price of “¥350”. A code “0002” defines “iced coffee” in the “drinks” category and sets a unit price of “¥350”.

Next, of processing executed by the microcomputer 201 in accordance with the OS and computer program installed in the HDD 208 of the information terminals 102, characteristic processing in the information terminals 102 according to this embodiment will be described.

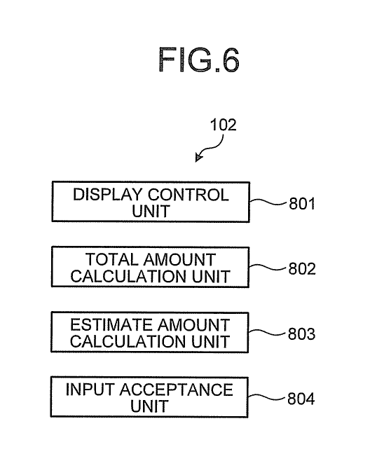

The computer program executed by the information terminals 102 according to this embodiment has a module configuration including units as shown in FIG. 6 (a display control unit 801, a total amount calculation unit 802, an estimate amount calculation unit 803, and an input acceptance unit 804). As actual hardware, the CPU 202 of the microcomputer 201 reads out the computer program from the HDD 208 and executes the computer program, thus loading the respective units onto the RAM 205. The display control unit 801, the total amount calculation unit 802, the estimate amount calculation unit 803 and the input acceptance unit 804 are thus generated on the RAM 205.

First, prior to the explanation of the module configuration shown in FIG. 6, processing to assist in order acceptance will be described.

In the microcomputer 201 of the information terminal 102, the CPU 202 displays, on the liquid crystal display 109, an order input screen D where functional information about menu order functions is arranged in plural areas D11 to D15 and D19, such as main buttons D11b and sub buttons D11c in a category tag section D11a, menu buttons D12b in the menu item section D12a, an order list D13a, buttons D13b, symbol buttons D13c, service designation keys D14a, function keys D15a, customer information input buttons D19a, a customer information section D19b, and a customer information addition button D19c, in accordance with the OS and computer program installed in the HDD 208, as shown in FIG. 7.

The microcomputer 201 arranges the main buttons D11b (“grand menu” and so on) showing category names registered in the category section 401b of the category file 401, in one row by six columns in the category tag section D11a. The microcomputer 201 also arranges the sub buttons D11c (“Japanese meals (wazen)” and so on) showing category names registered in the category section 401b corresponding to the category numbers 401a in the category file 401, in two rows by five columns in the category tag section D11a. The microcomputer 201 displays the main buttons D11b and the sub buttons D11c as objects that can be designated by touch on the touch panel 110.

In the initial state, the microcomputer 201 arranges the menu buttons D12b including the image data of link destinations defined by the image links 402c and the menu item names 402d corresponding to the codes 402a in the PLU (price lookup) file 402, in four rows by five columns in the menu item section D12a arranged in the area D12. The microcomputer 201 arranges the menu buttons D12b as objects that can be designated by touch on the touch panel 110, similarly to the main buttons D11b and the sub buttons D11c.

The microcomputer 201 arranges the order list D13a including a list of menu items, the number of orders and the amount (the unit price×the number of orders) designated by touch on the order input screen D through the touch panel 110, in the area D13. The microcomputer 201 also arranges the buttons D13b (“cancel”, “add same menu item” and so on) to execute cancelation and addition of a menu item included in the order list D13a, in one row by two columns in the area D13. Moreover, the microcomputer 201 arranges the symbol buttons D13c ( [symbol] and so on) to execute shift of a highlight indicating a menu item to be canceled or added, of the menu items included in the order list D13a, in one row by four columns in the area D13. The microcomputer 201 also arranges the buttons D13b and the symbol buttons D13c as objects that can be designated by touch on the touch panel 110.

The microcomputer 201 arranges the service designation keys D14a (“accounting”, “send order” and so on) to designate execution of various services such as execution of accounting or sending an order, in eight rows by one column in the area D14 as objects that can be designated by touch on the touch panel 110.

The microcomputer 201 arranges the function keys D15a (“increase quantity”, “reduce quantity” and so on) to designate execution of various functions such as execution of processing to increase the number of orders or processing to reduce the number of orders, in two rows by five columns in the area D15 as objects that can be designated by touch on the touch panel 110.

The microcomputer 201 the customer information input buttons D19a (“table No”, “number of people”, “slip”, “customer stratum” and so on) to input information about customers from which an order is to be accepted, in one row by four columns in the area D19 as objects that can be designated by touch on the touch panel 110. The microcomputer 201 also arranges the customer information section D19b (“Tokyo Restaurant Club member” or the like) inputted by the customer information input buttons D19a, in the area D19. Moreover, the microcomputer 201 arranges the customer information addition button D19c or the like to add customer information, in the area D19 as objects that can be designated by touch on the touch panel 110.

The microcomputer 201 displays the frame of each button (or each key) arranged in each area in the order input screen D and an image or diagram within each button, at a preset aspect ratio. The microcomputer 201 also arranges each button (or each key) arranged in each area in the order input screen D, in accordance with the number of rows and the number columns that are preset for each area.

In the order input screen D, when inputting a menu item, the operator can select a desired category from “drinks”, “desserts”, “Japanese meals”, “Japanese-Western meals”, “one-bowl meals”, “one-pot meals”, “udon & soba noodles”, “a la carte dishes”, and “healthy vegetables and salads” by designating a desired sub button D11c by touch. For example, if the sub button D11c of “a la carte dishes”, of the sub buttons D11c, is designated by touch, the microcomputer 201 displays the order input screen D for “a la carte dishes” shown as an example in FIG. 7.

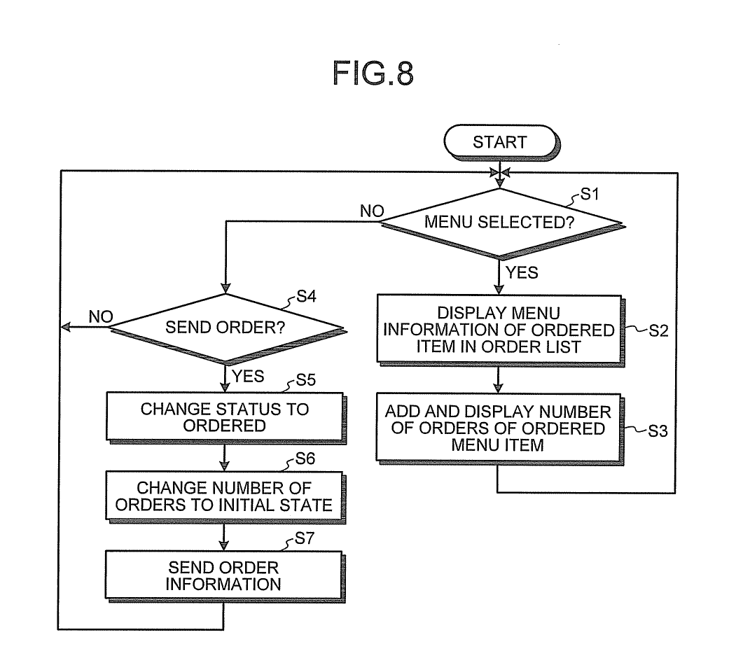

Next, order processing via the order input screen D as described above will be described. FIG. 8 is a flowchart showing the flow of order processing. As shown in FIG. 8, in order processing, if it is determined that one of the menu buttons D12b in the menu item section D12a in the order input screen D is touched and a menu item is thus selected (Yes in ACT 1), the microcomputer 201 of the information terminal 102 displays menu information (the number of orders, item name, and unit price) of the menu item designated by touch and thus ordered, in the order list D13a in the order input screen D (Act 2). The microcomputer 201 of the information terminal 102 also adds the count value of the number of orders of the ordered menu item, and displays the count value on the menu button D12b in the menu item section D12a in the order input section D (Act 3). The count value in the initial state is “0”. The initial state of count display on the menu button D12b is the state where the number of orders is not displayed, as shown in FIG. 7.

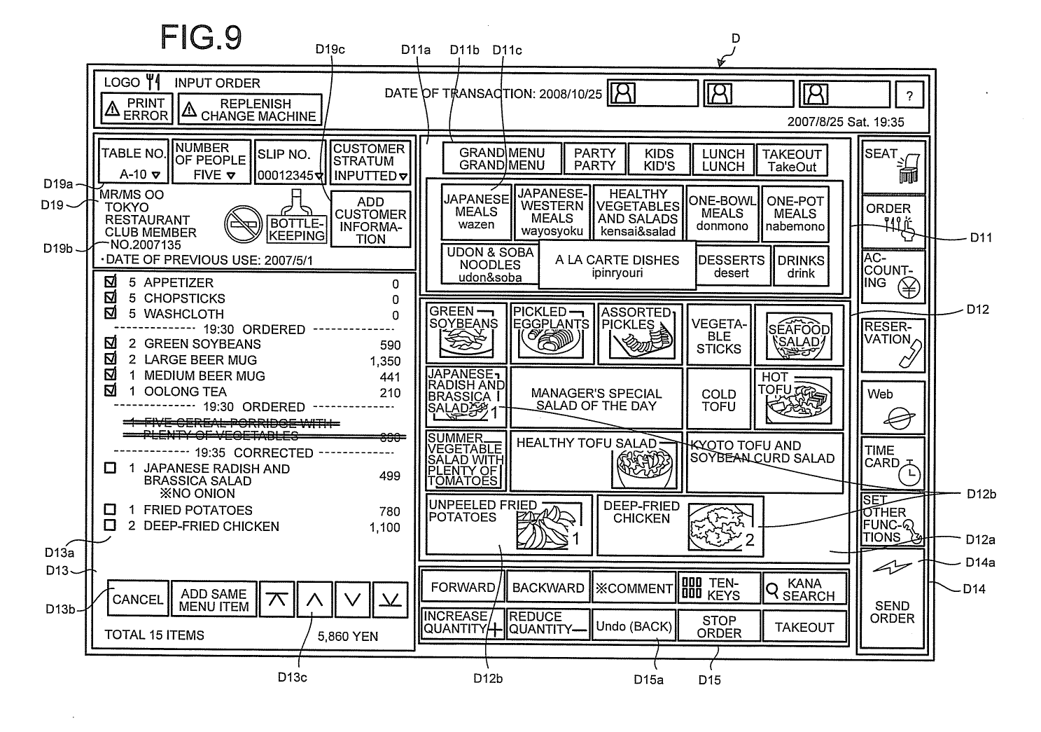

Here, the order list D13a in the order input screen D shown in FIG. 9 shows an example where one “Japanese radish and brassica salad”, one “fried potatoes”, and two “deep-fried chickens” are ordered. If one “Japanese radish and brassica salad”, one “fried potatoes”, and two “deep-fried chicken” are ordered, the microcomputer 201 displays a count value “1” indicating the number of orders on the menu button D12b of “Japanese radish and brassica salad”, a count value “1” indicating the number of orders on the menu button D12b of “fried potatoes”, and a count value “2” indicating the number of orders on the menu button D12b of “deep-fried chickens”, in the menu item section D12a in the order input screen D.

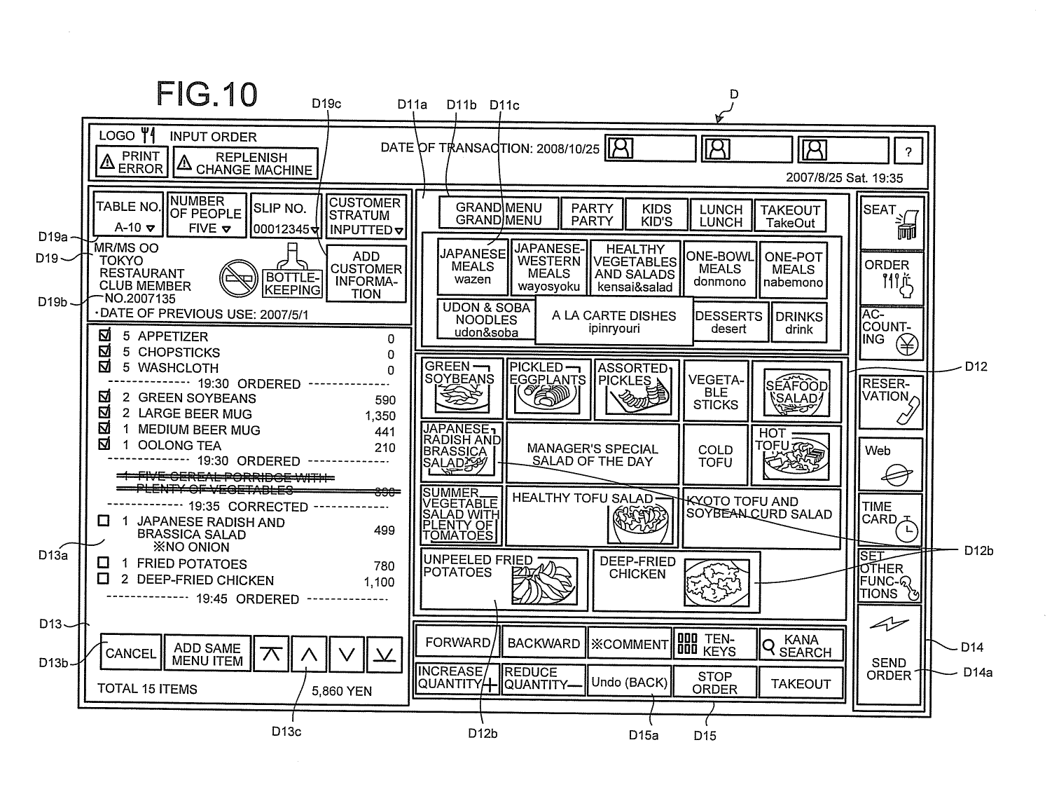

Referring again to the flowchart of FIG. 8, the processing of ACT 1 to ACT 3 as described above is repeated. If it is determined that the “send order” key of the service designation keys D14a is touched and sending of the order is designated (Yes in ACT 4), the microcomputer 201 changes the status of “Japanese radish and brassica salad”, “fried potatoes” and “deep-fried chickens” in the order list D13a in the order input screen D to “ordered” (ACT 5), as shown in FIG. 10. The microcomputer 201 also changes the count value indicating the number of orders on the menu buttons D12b of “Japanese radish and brassica salad”, “fried potatoes” and “deep-fried chickens” in the menu item section D12a in the order input screen D to “0” and restores the initial state of display of the number of orders (ACT 6).

In addition, the microcomputer 201 stores the “ordered” menu items, the number of orders, the amount (the unit price×the number of orders) and so on, displayed in the order list D13a in the order input screen D, as order information in the work area of the RAM 205 and sends the order information to the station 105 via the LAN (ACT 7).

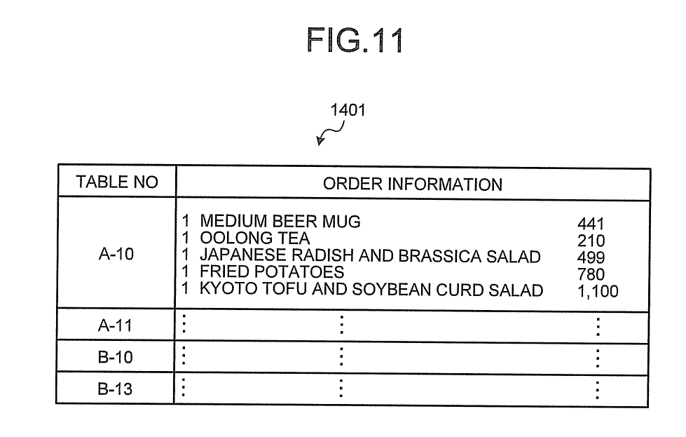

FIG. 11 is a schematic view showing the file structure of an order information file 1401 accumulated in the station 105. The station 105 stores order information sent from the information terminal 102 via the LAN, to the HDD 307 of the station 105 for each table number. Then, when executing accounting, the information terminal 102 that is installed on the checkout counter and functions as a POS terminal sends the table number to the station 105 and downloads order information corresponding to the table number for which accounting is to be carried out, from the order information file 1401 in the HDD 307 of the station 105 to the HDD 208 of the information terminal 102.

Before the “send order” key of the service designation keys D14a is operated, the user can increase or reduce the number of orders by operating the “increase quantity” key or the “reduce quantity” key of the functions keys D15a with respect to the number of orders in the order list D13a in the order input screen D and the number of orders on the menu button D12b.

Next, the module configuration shown in FIG. 6 will be described.

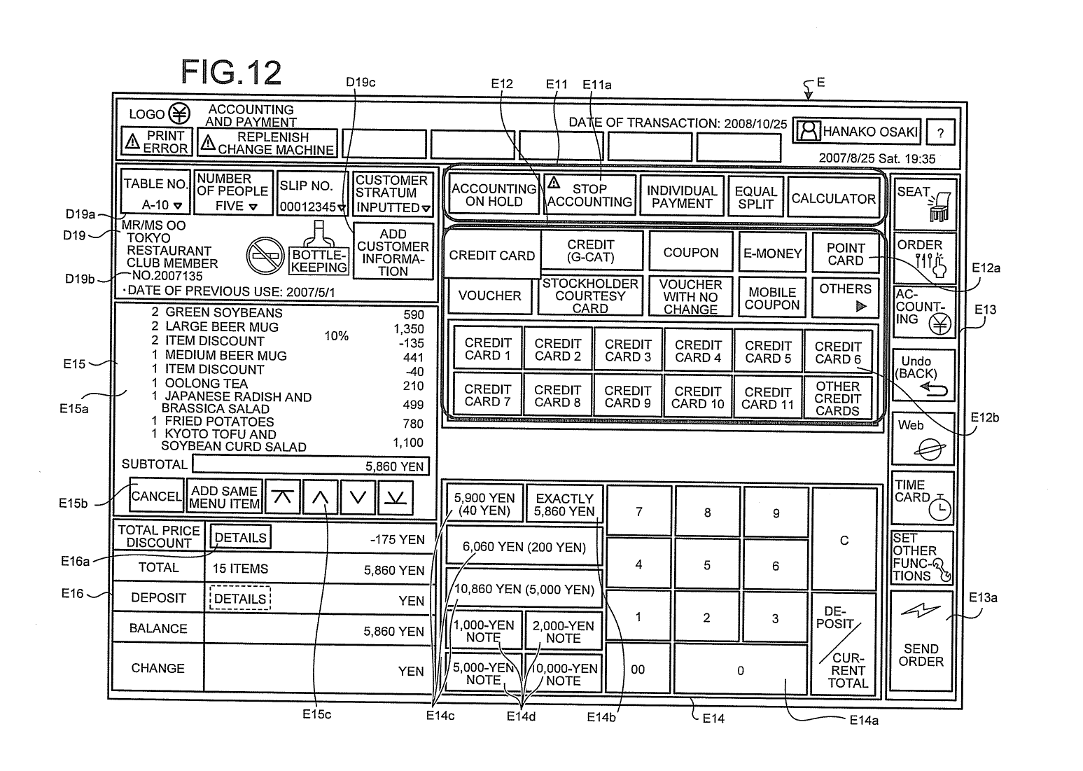

If the “accounting” key of the service designation keys D14a is operated, the display control unit 801 displays an accounting and payment operation screen E shown in FIG. 12 on the liquid crystal display 109. The display control unit 801 arranges, on the accounting and payment operation screen E, an accounting method button area E11, a payment method button area E12, a service designation area E13, a ten-key area E14, an order area E15, a total and deposit area E16, an area D19, and so on. The area D19 is similar to the order input screen D shown in FIG. 7 and therefore will not be described further in detail.

The display control unit 801 displays accounting method buttons Ella (“accounting on hold”, “stop accounting” and so on) for selection of an accounting method such as putting accounting on hold or stopping accounting and for payment, in the accounting method button area E11 as objects that can be designated by touch on the touch panel 110.

The display control unit 801 displays payment method buttons E12a (“credit card”, “voucher” and so on) for selection of a payment method such as payment by credit card or payment by voucher, and card company selection buttons E12b for selection of a card company in the case where payment by credit card is selected, in the payment method button area E12 as objects that can be designated by touch on the touch panel 110.

The display control unit 801 displays service designation keys E13a (“accounting”, “undo” and so on) to designate execution of various services such as execution of accounting or execution of processing to return to a screen that is displayed immediately before the order input screen D or the like, in the service designation area E13 as objects that can be designated by touch on the touch panel 110.

The display control unit 801 displays in the ten-key area E14 ten-keys E14a for input of one- or two-digit numbers, a total amount button E14b which shows an operation image for input of the total amount calculated by the total amount calculation unit 802, as will be described later, and which shows the total amount, estimate amount buttons E14c which show an operation image for input of the estimate deposit amount calculated by the estimate amount calculation unit 803, as will be described later, and which show the estimate deposit amount, and amount input buttons E14d that enable input of 1,000 yen, 2,000 yen, 5,000 yen and 10,000 yen by a single touch, in the ten-key area E14 as objects that can be designated by touch on the touch panel 110. The display control unit 801 provides fixed display of the amount input buttons E14d in the ten-key area E14.

The display control unit 801 arranges an order list E15a including a list of menu items, the number of orders and the amount (the unit price×the number of orders) included in the order information downloaded to the HDD 208, in the order area E15. The display control unit 801 also arranges buttons E15b (“cancel”, “add same menu item” and so on) to execute cancelation, addition or the like of a menu item included in the order list E15a, in one row by two columns in the order area E15. Moreover, the display control unit 801 arranges symbol buttons E15c ( [symbol] and so on) to execute shift of a highlight indicating a menu item to be canceled or added, of the menu items included in the order list E15a, in one row by four columns in the order area E15. The display control unit 801 also arranges the buttons E15b and the symbol buttons E15c as objects that can be designated by touch on the touch panel 110.

The display control unit 801 displays a list of the discount amount, the total amount, the deposit amount, the remaining amount, the change and so on in the total and deposit area E16. The display control unit 801 also displays keys E16a for processing to display details of the discount amount, the deposit amount and so on, in the total and deposit area E16 as objects that can be designated by touch on the touch panel 110.

The total amount calculation unit 802 calculates the total amount (the unit price×the number of orders) of ordered menu items, using the order information downloaded to the HDD 208.

The estimate amount calculation unit 803 calculates the estimate deposit amount as a result of adding, to the total amount calculated by the total amount calculation unit 802, the difference between the amount in the processing target digit (the digit used for calculation of the estimate deposit amount) of the total amount and the amount of a coin or banknote having a value more expensive than and immediately above the amount in the processing target digit. In this embodiment, the amount as a result of adding, to the total amount, the difference between the amount in the processing target digit of the total amount and the amount of a coin or banknote having a value more expensive than and immediately above the amount in the processing target digit, is calculated as the estimate deposit amount. However, the difference between the amount in the processing target digit of the total amount and the amount of any coin or banknote that is more expensive than the amount in the processing target digit may be added to the total amount.

More specifically, if the numeric value of the amount in the processing target digit is smaller than “5”, the estimate amount calculation unit 803 calculates the amount as a result of adding, to the total amount, the difference between the amount in the processing target digit and the amount of a coin or banknote having a numeric value “5” in the same digit as the processing target digit, as the estimate deposit amount. Meanwhile, if the numeric value of the amount in the processing target digit is “5” or greater, the estimate amount calculation unit 803 calculates the amount as a result of adding, to the total amount, the difference between the amount in the processing target digit and the amount of a coin or banknote having a value obtained by rounding up the same digit as the processing target digit to the next digit, as the estimate deposit amount.

For example, if the total amount calculated by the total amount calculation unit 802 is 335 yen, the estimate amount calculation unit 803 first calculates the estimate deposit amount using the amount in the units digit as the amount in the processing target digit. Specifically, since the numeric value “5” of the amount in the units digit (5 yen) corresponds to the case of “5” or greater, the estimate amount calculation unit 803 calculates the difference (5 yen) between the amount in the units digit (5 yen) and the amount of a coin (10 yen) having a value obtained by rounding up the amount in the units digit (5 yen) to the next digit, and adds the difference (5 yen) to the total amount (335 yen), thus calculating the estimate deposit amount (340 yen).

Next, the estimate amount calculation unit 803 calculates the estimate deposit amount using the amount in the tens digit as the amount in the processing target digit. Specifically, since the numeric value “3” of the amount (30 yen) in the tens digit is smaller than “5”, the estimate amount calculation unit 803 calculates the difference (20 yen) between the amount in the tens digit (30 yen) and the amount of a coin (50 yen) having a numeric value “5” in the tens digit, and adds the difference (20 yen) to the total amount (335 yen), thus calculating the estimate deposit amount (355 yen).

Moreover, the estimate amount calculation unit 803 calculates the estimate deposit amount using the amount in the hundreds digit as the amount in the processing target digit. Specifically, since the numeric value “3” of the amount (300 yen) in the hundreds digit is smaller than “5”, the estimate amount calculation unit 803 calculates the difference (200 yen) between the amount in the hundreds digit (300 yen) and the amount of a coin (500 yen) having a numeric value “5” in the hundreds digit, and adds the difference (200 yen) to the total amount (335 yen), thus calculating the estimate deposit amount (535 yen).

In the above example, the estimate amount calculation unit 803 calculates the estimate deposit amount where the amount in the units digit of the total amount calculated by the total amount calculation unit 802 is used as the amount in the processing target digit, the estimate deposit amount where the amount in the tens digit is used as the amount in the processing target digit, and the estimate deposit amount where the amount in the hundreds digit is used as the amount in the processing target digit. However, if the total amount is of four digits or greater, the estimate amount calculation unit 803 may calculate the estimate deposit amount where the amount in the thousands digit is used as the amount in the processing target digit. In this embodiment, if the total amount is of four digits or greater, it is assumed that the estimate deposit amount where the amount in the tens digit is used as the amount in the processing target digit, the estimate deposit amount where the amount in the hundreds digit is used as the amount in the processing target digit, and the estimate deposit amount where the amount in the thousands digit is used as the amount in the processing target digit, are calculated.

When inputting the deposit amount in the accounting and payment operation screen E, if the ten-keys E14a, the total amount button E14b or the estimate amount buttons E14c and so on are designated (operated) by touch, the input acceptance unit 804 accepts input of the total amount calculated by the total amount calculation unit 802 or the estimate deposit amount calculated by the estimate amount calculation unit 803, corresponding to the total amount button E14b or the estimate amount buttons E14c. For example, if the estimate amount button E14c showing “6,060 yen” displayed in the ten-key area E14 is designated (operated) by touch, the input acceptance unit 804 accepts input of “6,060 yen” as the deposit amount. The display control unit 801 then displays the deposit amount with its input accepted by the input acceptance unit 804, in the deposit amount section in the total and deposit area E16 as shown in FIG. 12.

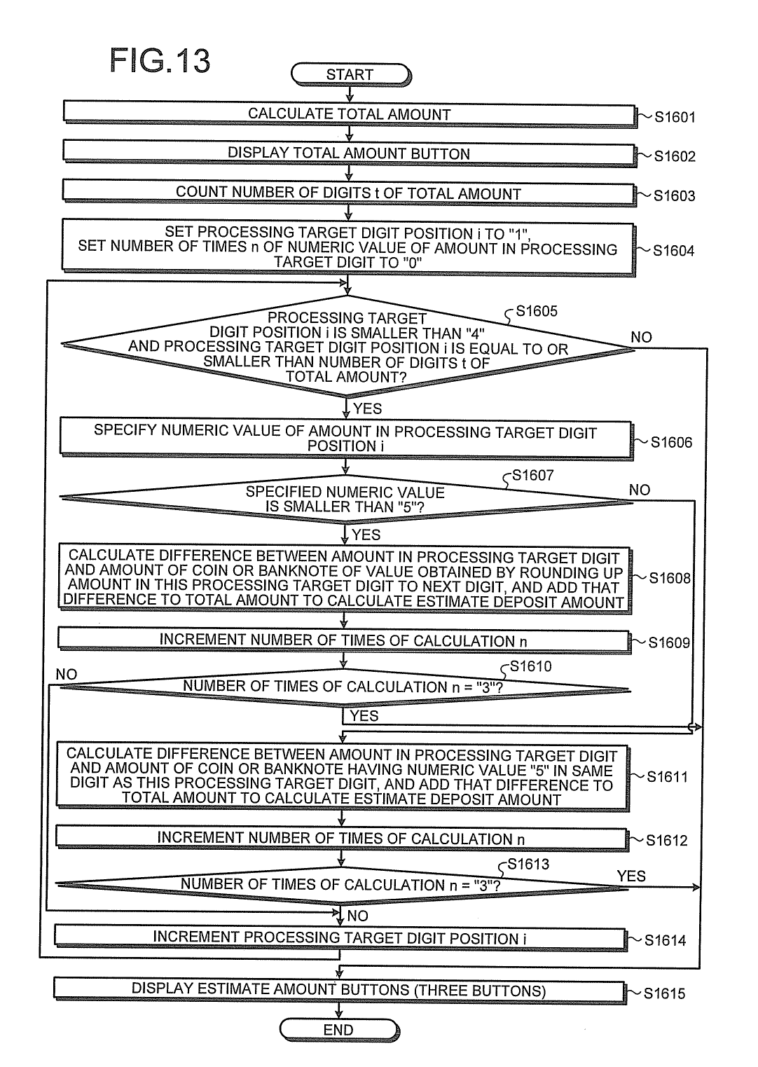

Next, processing to display the total amount button E14b and the estimate amount buttons E14c in the ten-key area E14 will be described with reference to FIG. 13. FIG. 13 is a flowchart showing the flow of the processing to display the total amount button E14b and the estimate amount buttons E14c in the ten-key area E14.

First, the total amount calculation unit 802 calculates the total amount (for example, 5,860 yen) for ordered menu items (ACT 1601). The display control unit 801 displays the total amount button E14b showing the total amount calculated by the total amount calculation unit 802, in the ten-key area E14 (ACT 1602).

Next, the estimate amount calculation unit 803 counts the number of digits t: “4” of the total amount calculated by the total amount calculation unit 802 (ACT 1603). Then, the estimate amount calculation unit 803 sets the position i of the processing target digit to “1” and sets the number of times n the estimate deposit amount is calculated to “0” (ACT 1604). In this example, the processing target digit position is “1” indicates that the tens digit of the total amount is the processing target digit. A processing target digit position is “2” indicates that the hundreds digit of the total amount is the processing target digit. A processing target digit position i: “3” indicates that the thousands digit of the total amount is the processing target digit.

Next, the estimate amount calculation unit 803 determines whether or not the set processing target digit position i is smaller than “4” and the set processing target digit position i is equal to or smaller than the number of digits t: “4” of the total amount counted in ACT 1603 (ACT 1605).

If the set processing target digit position i is smaller than “4” and the set processing target digit position i is equal to or smaller than the counted number of digits t: “4” of the total amount (Yes in ACT 1605), the estimate amount calculation unit 803 first specifies the numeric value “6” in the amount (60 yen) corresponding to the set processing target digit position is “1” (ACT 1606), and determines whether the specified numeric value “6” is smaller than “5” or not (ACT 1607).

If it is determined that the specified numeric value is smaller than “5” (Yes in ACT 1607), the estimate amount calculation unit 803 calculates the difference between the amount in the processing target digit position i and the amount of a coin or banknote having a numeric value “5” in the same digit as the processing target digit position i, and adds the difference to the total amount, thus calculating the estimate deposit amount (ACT 1608). The estimate amount calculation unit 803 also increments the number of times of calculation n (ACT 1609). Then, the estimate amount calculation unit 803 determines whether the incremented number of times of calculation n is “3” or not (ACT 1610).

If it is determined that the incremented number of times of calculation n is not “3” (No in ACT 1610), the estimate amount calculation unit 803 increments the processing target digit position i (ACT 1614) and goes back to ACT 1605.

Meanwhile, if it is determined that the specified numeric value “6” is equal to or greater than “5” (No in ACT 1607), the estimate amount calculation unit 803 calculates the difference (40 yen) between the amount (60 yen) in the processing target digit position is “1” and the amount (100 yen) of a coin having a value obtained by rounding up the amount (60 yen) in the processing target digit position i: “1” to the next digit, and adds the difference (40 yen) to the total amount (5,860 yen), thus calculating the estimate deposit amount (5,900 yen) (ACT 1611). The estimate amount calculation unit 803 also increments the number of times of calculation n (ACT 1612). Then, the estimate amount calculation unit 803 determines whether the incremented number of times of calculation n: “1” is “3” or not (ACT 1613).

If it is determined that the incremented number of times of calculation n: “1” is not “3” (No in ACT 1613), the estimate amount calculation unit 803 increments the processing target digit position i (ACT 1614) and goes back to ACT 1605.

Next, if it is determined that the set processing target digit position is “2” is smaller than “4” and the set processing target digit position is “2” is equal to or smaller than the counted number of digits t: “4” of the total amount (Yes in ACT 1605), the estimate amount calculation unit 803 specifies the numeric value “8” in the amount (800 yen) corresponding to the set processing target digit position is “2” (ACT 1606) and determines whether the specified value “8” is smaller than “5” or not (ACT 1607).

If it is determined that the specified value “8” is equal to or greater than “5” (No in ACT 1607), the estimate amount calculation unit 803 calculates the difference (200 yen) between the amount (800 yen) in the processing target digit position is “2” and the amount (1,000 yen) of a banknote having a value obtained by rounding up the amount (800 yen) in the processing target digit position is “2” to the next digit, and adds the difference (200 yen) to the total amount (5,860 yen), thus calculating the estimate deposit amount (6,060 yen) (ACT 1611). The estimate amount calculation unit 803 also increments the number of times of calculation n (ACT 1612). The estimate amount calculation unit 803 then determines whether the incremented number of times of calculation n: “2” is “3” or not (ACT 1613).

If it is determined that the incremented number of times of calculation n: “2” is not “3” (No in ACT 1613), the estimate amount calculation unit 803 increments the processing target digit position i (ACT 1614) and goes back to ACT 1615.

Next, if it determined that the set processing target digit position is “3” is smaller than “4” and the set processing target digit position is “3” is equal to or smaller than the counted number of digits t: “4” of the total amount (Yes in ACT 1605), the estimate amount calculation unit 803 specifies the numeric value “5” in the amount (5,000 yen) corresponding to the set processing target digit position i: “3” (ACT 1606) and determines whether the specified value “5” is smaller than “5” or not (ACT 1607).

If it is determined that the specified value “5” is equal to or greater than “5” (No in ACT 1607), the estimate amount calculation unit 803 calculates the difference (5,000 yen) between the amount (5,000 yen) in the processing target digit position is “3” and the amount (10,000 yen) of a banknote having a value obtained by rounding up the amount (5,000 yen) in the processing target digit position is “3” to the next digit, and adds the difference (5,000 yen) to the total amount (5,860 yen), thus calculating the estimate deposit amount (10,860 yen) (ACT 1611). The estimate amount calculation unit 803 also increments the number of times of calculation n (ACT 1612). The estimate amount calculation unit 803 then determines whether the incremented number of times of calculation n: “3” is “3” or not (ACT 1613).

If it is determined that the incremented number of times of calculation n: “3” is “3” (Yes in ACT 1610, Yes in ACT 1613), or if it is determined that the processing target digit position is smaller than “4” and the processing target digit position is not equal to or smaller than the number of digits of the total amount t: “4” (No in ACT 1605), the display control unit 801 displays the estimate amount buttons E14c (three buttons) showing the estimate deposit amounts (5, 900 yen, 6,060 yen and 10,860 yen) calculated by the estimate amount calculation unit 803, in the ten-key area E14 (ACT 1615). The amount of change with respect to the estimate amount is shown in ( ). The display of 5,900 yen (40 yen) represents that the estimate deposit amount is 5,900 yen and the amount of change is 40 yen. The display of 6,060 yen (200 yen) represents that the estimate deposit amount is 6,060 yen and the amount of change is 200 yen. The display of 10,860 yen (5,000 yen) represents that the estimate deposit amount is 10,860 yen and the amount of change is 5,000 yen.

According to this embodiment, the estimate deposit amounts are calculated and the estimate amount buttons E14c showing the calculated estimate deposit amounts are displayed in the ten-key area E14. Therefore, the estimated deposit amounts can be inputted in one operation and thus the operator's work to input the deposit amounts can be reduced. Moreover, since the amounts of change with respect to the estimate deposit amounts are displayed simultaneously, the operator can grasp the amounts of change in advance.

Further advantages and modifications can be easily led out by those skilled in the art. Therefore, broader embodiments of the invention are not limited to the specific details and representative embodiments described and shown above. Thus, various modifications and alterations can be made without departing from the comprehensive spirit and scope of the invention defined by the attached claims and their equivalents.

What is claimed is:

1. An accounting device comprising:
a first calculation unit which calculates a total amount for ordered menu items;
a second calculation unit which calculates an estimate deposit amount as a result of adding, to the total amount calculated by the first calculation unit, a difference between an amount in a processing target digit of the total amount and an amount of a coin or banknote that is more expensive than the amount in the processing target digit;
a display control unit which displays an operation image to input the estimate deposit amount calculated by the second calculation unit; and
an input acceptance unit which accepts input of the estimate deposit amount calculated by the second calculation unit corresponding to the operation image when the displayed operation image is operated.

2. The device according to claim 1, wherein the second calculation unit calculates the estimate deposit amount as a result of adding, to the total amount calculated by the first calculation unit, a difference between the amount in the processing target digit and an amount of a coin or banknote that is more expensive than and immediately above the amount in the processing target digit.

3. The device according to claim 1, wherein the second calculation unit calculates the estimate deposit amount every time the total amount is calculated by the first calculation unit.

4. The device according to claim 1, wherein the display control unit displays the operation image showing the estimate deposit image calculated by the second calculation unit.

5. The device according to claim 1, wherein the display control unit displays an operation image showing the total amount calculated by the first calculation unit and adapted for inputting the total amount.

6. An accounting method comprising:
calculating a total amount for ordered menu items;
calculating an estimate deposit amount as a result of adding, to the calculated total amount, a difference between an amount in a processing target digit of the total amount and an amount of a coin or banknote that is more expensive than the amount in the processing target digit;
displaying an operation image to input the calculated estimate deposit amount; and
accepting input of the estimate deposit amount corresponding to the operation image when the displayed operation image is operated.

7. The method according to claim 6, wherein the estimate deposit amount as a result of adding, to the calculated total amount, a difference between the amount in the processing target digit and an amount of a coin or banknote that is more expensive than and immediately above the amount in the processing target digit, is calculated.

8. The method according to claim 6, wherein the estimate deposit amount is calculated every time the total amount is calculated.

9. The method according to claim 6, wherein the operation image showing the calculated estimate deposit image is displayed.

10. The method according to claim 6, wherein an operation image showing the calculated total amount and adapted for inputting the total amount is displayed, and
when the operation image for inputting the total amount is operated, input of the total amount corresponding to the operation image is accepted.
